(19) United States
(12) Patent Application Publication
(10) Pub. No.: US 2013/0327475 A1
(43) Pub. Date: Dec. 12, 2013

(54) METHOD AND APPARATUS FOR FIXING RIGID DECORATIVE ELEMENTS ON A SUBSTRATE, AND TRANSFER STRIP WITH DECORATIVE ELEMENTS

(71) Applicant: Roland F. Gratzer, Wien (AT)

(72) Inventor: Roland F. Gratzer, Wien (AT)

(73) Assignee: GRATZER! TECHNOLOGIES GMBH & CO. KG, Wien (AT)

(21) Appl. No.: 14/001,840

(22) PCT Filed: Feb. 28, 2012
(86) PCT No.: PCT/EP12/00865

§ 371 Date: Aug. 27, 2013

Related U.S. Application Data
(60) Provisional application No. 61/447,554, filed on Feb. 28, 2011.

(51) Int. Cl. B44C 1/18

(52) U.S. Cl. CPC B44C 1/18
USPC 156/238; 156/538

(57) ABSTRACT

An apparatus (400) for transferring decorative rigid bodies (18) each having at least one flat side (24) from a carrier strip (10) carrying the decorative rigid bodies (18) onto a substrate (60) is disclosed. The apparatus (400) comprises a holding fixture (32c), such as a holding fixture (32c), for accommodating a part of the carrier strip (10) with the decorative rigid bodies (18), a reel (34c) for receiving a part of the carrier strip (10) from which the decorative rigid bodies (18) have been transferred to the substrate (60) and a reciprocator (410), such as a hammer or a plunger, located at a position between the holding fixture (32c) and the reel (34c) as measured along the carrier strip (10), and adapted for individually bringing the decorative rigid bodies (18) into contact with the substrate (60).

### CROSS-REFERENCES TO RELATED APPLICATIONS

The present application claims priority of Patent Application No. 01472/2010, filed Sep. 3, 2010 in Switzerland, entitled “Vorrichtung zum positionsgenauen Applizieren von Elementen auf eine Fläche eines Gegenstandes”, the contents of which is hereby incorporated by reference in its entirety.

### FIELD

The invention relates to a method and an apparatus for transferring decorative elements onto a substrate, and to a transfer strip carrying such decorative elements.

### BACKGROUND

Decorative patterns are usually transferred from a carrier sheet onto a substrate to be decorated. The technique is generally limited to flexible decorative sheets. For such sheets, it may be cumbersome to properly arrange the carrier sheet on the substrate, e.g. without wrinkles. Yet, the applicant is not aware of any means for transferring rigid decorative elements onto a substrate.

It would be desirable to have available means for decorating a substrate with rigid decorative elements. In particular, it would be desirable to have available a ribbon-like material, with which rigid decorative elements can readily be applied to a substrate. It would be even more desirable to have available a cartridge containing such ribbon-like material and an apparatus for transferring rigid decorative elements from the ribbon-like material onto the substrate.

### SUMMARY

Embodiments relate to an apparatus for transferring decorative rigid bodies each having at least one flat side from a carrier strip carrying the decorative rigid bodies onto a substrate. The apparatus comprises a holding fixture for accommodating a part of the carrier strip with the decorative rigid bodies, a reel for receiving a part of the carrier strip from which the decorative rigid bodies have been transferred to the substrate and a reciprocator located at a transfer position between the holding fixture and the reel as measured along the carrier strip, and adapted for individually bringing the decorative rigid bodies into contact with the substrate by substantially linear movement of the reciprocator. The holding fixture may be a disk-shaped cavity or a cavity supporting a reel carrying the carrier strip, for example. In this respect, “substantially linear movement” is to be interpreted in a way that an exclusively rotational movement of the reciprocator is excluded. Thus, movement of the reciprocator must have a linear component or be purely linear and thus run along a straight line. The reciprocator may be a linear reciprocator such as a hammer or a plunger, for example. Furthermore, with respect to the decorative rigid bodies “flat side” may refer either to a plane side and/or a sphere having a radius of curvature of more than 30 cm and especially more than 60 cm, and/or a side fitting into a spherical surface having a radius of curvature of more than 30 cm and especially more than 60 cm.

According to an embodiment the apparatus comprises an actuator for the reciprocator, which is mounted in reciprocating manner so that an outward motion of the reciprocator is registered with a transportation of the carrier strip from the holding fixture to the reel, and the reciprocator is arranged to exert a force onto the carrier strip such that the flat side of at least one of the decorative rigid bodies is protruded from the apparatus.

According to an embodiment the reciprocator is mounted on or in a casing, and the casing is movable in reciprocating manner in a protrusion direction of the at least one of the decorative rigid bodies.

According to an embodiment the reciprocator is resiliently mounted on and/or in the casing, wherein a gear is provided which synchronizes a translational motion of the reciprocator with respect to the casing into a forwarding motion of the carrier strip.

According to an embodiment the gear includes a lever and a timing wheel engaging the carrier strip, wherein the lever engages on its one part with the reciprocator and on its other part with the timing wheel such that the reciprocating motion of the reciprocator causes an alternate blocking and releasing of the timing wheel with the other part of the lever.

According to an embodiment the timing wheel includes a timing disk carrying six, seven or eight protrusions for engagement with the other part of the lever. According to an embodiment the timing wheel is mounted coaxially to the timing wheel. According to an embodiment the protrusions are extending in parallel to an axis of the timing wheel. According to an alternative embodiment the protrusions are extending in radial direction of the timing disk.

According to an embodiment a pitch between the protrusions on the timing disk is larger than a pitch between engagement features of the carrier strip. According to an embodiment the pitch between the protrusions on the timing disk may be less than 10% and especially less than 6% and further especially less than 3% larger than a pitch between engagement features of the carrier strip. According to an embodiment the pitch between the protrusions on the timing disk may be more than 1% larger than a pitch between engagement features of the carrier strip.

According to an embodiment the timing wheel engages the carrier strip at a position upstream of the transfer position. In other terms the timing wheel is arranged in-between the transfer position and the holding fixture.

It is mentioned that the terms “upstream” and “downstream” as used in the present application are measured along a long side of the carrier strip when the carrier strip is mounted in the apparatus.

According to an embodiment the timing wheel comprises bosses adapted to engage engagement features of the carrier strip, wherein a pitch between the bosses of the timing wheel is substantially identical to a pitch between engagement features of the carrier strip. In this respect, substantially identical means that the pitch between the bosses of the timing wheel is identical or less than 2% and especially less than 1% larger than the pitch between engagement features of the carrier strip. It is emphasized that the bosses of the timing wheel do not need to have a circular cross section. In fact, the cross section of the bosses may be circular, semicircular, rectangular, triangular, for example. A circular or semicircular as well as a triangular cross section of the bosses may facilitate interaction between the bosses and the engagement features of the carrier strip. According to embodiments, the bosses protrude in radial direction from the timing wheel. According to another embodiment, which may be combined with the previous embodiment, the bosses protrude in axial direction from the timing disk.

According to an embodiment, the timing wheel and/or the timing disk may carry six, seven or eight bosses for engaging engagement features of the carrier strip. According to an embodiment, the number of bosses and the number of protrusions of the timing disk are the same.

According to an embodiment the casing has a stop extending from the apparatus in the protrusion direction, the stop being arranged for blocking the movement of the casing upon contact with the substrate, such that the movement of the reciprocator continues, resulting in a relative movement of the reciprocator and the casing. Thus, the casing may be moved by moving the reciprocator and movement of the casing is stopped as soon as the stop comes into contact with the substrate.

According to an embodiment the stop may consist of three or more knobs surrounding the transfer position and defining a mathematical contact plane for the substrate. In this case, linear movement of the reciprocator may include an angle of between 60° and 120° and especially 80° and 100° and further especially 90° with respect to the mathematical contact plane.

According to an embodiment the actuator includes a bushing mounted eccentrically to the reciprocator.

According to an embodiment the bushing surrounds the part of the carrier strip from which the decorative rigid bodies have been transferred to the substrate at least in sections between the transfer position and the reel.

According to an embodiment the apparatus comprises a downstream guide wheel located between the transfer position and the reel for guiding the carrier strip towards the reel after the decorative rigid bodies have been transferred.

According to an embodiment the apparatus comprises an upstream guide wheel located between the holding fixture and the timing wheel for guiding the carrier strip carrying decorative bodies around the timing wheel.

According to an embodiment the upstream guide wheel is arranged to cause the carrier strip to bend around the timing wheel by an angle of from 20° to 120° and especially by an angle from 25° to 45°. Thus, a substantial part of the carrier strip comes into contact with the timing wheel to make sure that the carrier strip does not slip of the timing wheel. In case the timing wheel and/or the timing disk comprises bosses adapted to engage engagement features of the carrier strip, it is preferred that the guide wheel is arranged in a way that at least two bosses engage with the engagement features of the carrier strip at any time.

According to an embodiment the apparatus comprises a means for tensioning the carrier strip towards the reel. These means may include a spring such as a main spring, coil spring, windup mechanism, electrical motor, for example. However, the present invention is not limited to the listed tensioning means.

According to an embodiment the means are a coil spring connected between the reel or a matching disc interacting with the reel and the casing.

According to an embodiment the tensioning means are connected to the casing in a way allowing easy release of the tensioning means e.g. by snap fit or quick fasteners.

According to an embodiment the releasable part is arranged to engage with the reel when connected to the casing.

According to an embodiment two matching disks on the releasable part and on the reel provide the engagement, respectively. According to an embodiment, the matching discs may be cogwheel having cogs protruding in axial direction of the wheels.

According to an embodiment the apparatus comprises removable blocking means arranged to impede rotation of the reel when the tensioning means are tensioned.

According to an embodiment the blocking means comprise a pin and matching holes in the reel disk and in the casing.

According to an aspect, a transfer strip carrying an array of decorative elements is provided, wherein the transfer strip has a top layer and a spacer layer having apertures or through-holes within which the decorative element are attached to the top layer. The spacer layer has sufficient resiliency to be compressed by the exertion of a force on the top layer, such that the decorative elements project into or beyond the spacer layer surface plane. The decorative elements have flat outward sides to which an adhesive is applied. In this manner, the outward flat sides, when coming into contact with the substrate, adhere to the latter. It is then possible, upon releasing the applied force and instead exerting a drag on the top layer, to remove the transfer strip without the decorative elements, which are left behind adhered to the substrate.

According to a further aspect, a method for fixing rigid decorative elements onto a substrate is provided, wherein a transfer strip carrying the decorative elements within through holes of a spacer layer is provided and pressure is exerted on a top layer of the transfer strip towards the substrate, thereby compressing the spacer layer such that an adhesive provided on flat sides of the decorative elements comes into contact with the substrate and adheres the decorative elements thereto.

According to yet another aspect, an apparatus has a first reel carrying a carrier strip with decorative elements, and a second reel for receiving the carrier strip after transfer of the decorative elements to the substrate. In between the first reel and the second reel, there is provided a rotating cam, a reciprocating hammer, or a transfer reel, for urging the respective decorative element to be transferred towards and onto the substrate. In the case where a transfer reel is present, same may be provided in a casing, partly protruding therefrom, the casing as a whole being reciprocatingly (in reciprocating manner) movable in the direction of the protrusion.

According to still another aspect, a cartridge has a first reel on which is wound a first portion of a carrier strip without decorative rigid bodies, and a second reel on which is wound a second portion of the carrier strip including an array of decorative rigid bodies. The carrier strip further has a protective layer having apertures in which the rigid bodies, where present, are located so as to be laterally protected. The protective layer is slightly thicker than the rigid bodies so that in the state wound on the second reel, the rigid bodies do not contact the neighboring turn of the carrier strip. The decorative rigid bodies may have flat outside faces bearing an adhesive.

The decorative elements provided on the transfer strip can readily be adhered on a substrate by exerting pressure on the back side of the transfer strip either manually, or using the apparatus, so that the flat sides of the elements bearing an adhesive come into contact with the substrate. It is thereby readily possible to arrange the decorative elements in regular one-, two- or even three-dimensional patterns. It is also possible to arrange the decorative elements in rectangular, quadratic or polygonal patterns. As an example, the elements may surround a framed photograph.

The transfer strip, or tape, generally comprises three parts, namely a top layer, a spacer layer with apertures, and the decorative elements to be transferred. The elements are positioned in the apertures or through holes of the spacer layer, so that they are laterally surrounded by the same. The top layer has an adhesive coated on its bottom side which holds the spacer layer and the decorative elements in place until transfer of the latter is executed. The spacer layer not only protects the decorative elements laterally, but also provides enhanced stability of the entire transfer strip. Additionally, it allows a strong adhesive being used on the entire bottom side of the top layer, without having to fear damage to the substrate when the transfer strip is brought in contact with the same. This is because the interposed spacer layer has no adhesive on its bottom side, but only adheres to the top layer.

The spacer layer is slightly thicker than the decorative elements accommodated in its apertures as long as no force is applied onto the top layer. Accordingly, the decorative elements may have an adhesive applied on their flat bottom faces, without their sticking to any flat substrates. The transfer strip may even be wound into a coil, without the decorative elements' bottom sides contacting the top side of the adjacent top layer and adhering thereto. However, when a force is exerted on the top layer, with the spacer layer being in contact with a substrate, the resiliency of the spacer layer provides for its reduction in thickness, thereby allowing the decorative elements to come into contact with the substrate and to adhere thereto. Thereafter, when the force is released, the elasticity of the spacer layer urges the top layer away from the substrate, aiding in releasing the decorative elements from the top layer. To this end, the adhesion experienced by each of the decorative elements towards the intended substrate should preferably be higher than the adhesion each of the decorative elements towards the top layer. This may be accomplished by accordingly adjusting the type of adhesive, or the area provided with the adhesive. E.g., the decorative elements may have a planar-convex shape providing a small contact area on their convex top portion facing towards the top layer, and a larger planar bottom portion facing, in use, towards the substrate. It should be taken into account that when removing the transfer strip from the substrate, this involves more or less upward bending of the top layer, so that the adhesion between the top layer and the decorative elements is released progressively, keeping the total force exerted on the respective decorative element comparatively low. On the other hand, the substrate does not bend to the same extent, if at all, and the total force required for the entire contact area to release has to be overcome if the decorative elements are to be removed from the substrate. Therefore, the adhesive between the decorative elements and the top layer need not be particularly weak.

The transfer strip may further include registration holes arranged at the same pitch as the decorative elements, an integer multiple thereof, or at least a commensurate pitch. When such registration holes are present, it is desirable if they are located sufficiently far removed towards the rims of the strip that their lengthwise projection does not overlap that of the apertures in the spacer layer housing the decorative elements. This is to ensure proper sealing of the apertures, without allowing atmosphere access in the wound state of the transfer strip. In this way, it can be accomplished that in the wound state of the transfer strip, the adhesive provided on the bottom sides of the decorative elements cannot lose its adhesive potential by drying or other interaction with the atmosphere.

Furthermore, the transfer strip may have features allowing for easy separating or rupturing it at predefined places. Such separator marks exemplarily include a reduced cross section of the transfer strip, e.g. by notches or perforations. The notches or perforations are desirably provided at positions, in the lengthwise extension of the transfer strip, between the through holes accommodating the decorative elements. It is not required, albeit useful, that the spacing between consecutive separator marks is in any respect regular, or correlated to the pitch of the elements. In order to provide maximum flexibility for the user, separator marks may be provided between every two successive decorative elements or the respective apertures.

In the above explained embodiments, the array of decorative elements may be a linear array, or any two-dimensional array. E.g., the provision of a double row of decorative elements is contemplated, to be transferred in pairs. Alternatively, e.g. a staggered arrangement is also possible. In some application, more involved arrangements, such as along circular or other curved lines, may be desirable. Some sort of symmetry may be present, such as mirror symmetry with respect to the lengthwise centerline of the strip.

In some exemplary embodiments, a carrier strip is housed in a cartridge containing a first reel and a second reel. A portion of the strip having no decorative elements is wound on the first, receiving reel, while a portion of the strip being provided with decorative elements is wound on the second, dispensing reel. The first reel is adapted to have a drive associated with it, e.g. by being provided with a biasing coil spring, or a hub adapted to engage a driving shaft. The second reel may be provided with a tensioning device such as a friction brake keeping the carrier strip straight between the two reels. The two reels may, in use, rotate in the same or in different directions. Usually, it may be advantageous to have them rotating in the same direction, as in this arrangement it is easier to ascertain that the two reels remain located on the same side of the carrier strip, namely the top side of that portion of the carrier strip between the two reels. In this arrangement, the bottom sides of the decorative elements face away from the two reels, which accordingly cannot interfere with the substrate when transfer is to be accomplished. Additional guide reels may be provided in order to let a transfer portion of the strip exposing bottom faces of decorative elements to the outside protrude from the cartridge. In such an arrangement, a transfer reel may be present which, upon turning, exposes the decorative elements one by one or pair by pair, as the case may be, so that the element(s) currently exposed may be pressed onto the substrate either manually or by a mechanism moving the entire cartridge towards the substrate in registration with the exposing of the decorative elements. In the above cartridges, the carrier strip may be the transfer strip described above.

In some exemplary embodiments, an apparatus houses not only the carrier strip and the dispensing and receiving reels, but also an actuator mechanism by which the decorative elements are urged onto the substrate. To this end, the apparatus may comprise a rotating cam, or a reciprocating hammer or the like. The cam or hammer or other mechanism is positioned between the two reels on the top side of the carrier strip, and is arranged to exert a force onto the top layer when in registration with one of the decorative elements. E.g. a cam may be provided on a cam reel rotating in a manner that the cam abuts against the top layer each time a decorative element passes the contact position. In another exemplary embodiment, a hammer may be provided in a guiding structure so as to be reciprocatingly (in reciprocating manner) movable away from and towards the top side of the carrier strip, so as to be urged towards the carrier strip each time a decorative element is positioned at the impact position, to thereby exert a force onto the top layer, and as a result bringing the decorative element into adhering contact with the substrate. The reciprocating movement may be a straight motion, but may also be a curved motion. Mixed forms involving both a reciprocating motion and a rotating motion may also be envisaged if desired, although usually adding to the complexity and cost of the apparatus.

The actuator drive may be accommodated in the same housing as the reels and carrier strip; in some applications, it is more desirable to provide the drive, necessary circuitry and power supply (such as a battery) in a different casing to be attached to the casing housing the carrier strip and reels. In this manner, the casing with the reels and carrier strip may be made replaceable, while the casing housing the drive, circuitry and battery remains in place. To this end, in some embodiments, the actuator or drive protrudes from the resident casing, to engage the cam or hammer, as the case may be, of the replaceable casing upon mounting the same on the resident casing. Herein, the replaceable casing may take the form of the cartridge described above. In exemplary embodiments, the apparatus includes a mechanism for reciprocatingly (in reciprocating manner) moving the entire structure away from and towards the substrate, in which case there is no need to differentiate between the casings. This is particularly useful in combination with a transfer reel protruding from the structure, as explained above.

Whether the transfer or carrier strip is provided alone or housed in a cartridge or a casing of an apparatus, the method for fixing decorative elements onto a substrate in exemplary embodiments comprises placing the strip on the substrate, exerting a sufficient force on its top side so that the spacer layer is somewhat compressed in order to bring the decorative elements bearing the adhesive on their bottom faces into contact with the substrate, releasing the force, and removing the spacer layer of the transfer strip from the substrate, leaving the decorative elements adhered to the substrate. Since there is an adhesive force acting between the decorative elements and the top layer, it is usually required to apply some sort of drag on the transfer strip or one of its components (top layer and spacer layer) in order to release the adhesive bond. In so doing, it may be desirably to apply some bending on the top layer, as this may aid in reducing the force required for overcoming the adhesion, as explained above. When the method is executed manually, it may also be advantageous to apply a lengthwise force on a portion of the strip still carrying decorative elements, so that the strip will rupture at the separator mark nearest the last adhered decorative element. When the method is executed automatically, e.g. by one of the apparatus described above, the apparatus may detect a registration mark provided on the strip and initiate the exertion of the force in dependence thereof and either at a predetermined time after detection of the mark, or at a predetermined position relative to the detected mark.

Embodiments relate to a transfer strip including an array of decorative rigid bodies each having at least one flat side, a top layer and a spacer layer. The top layer is adhered to the array of decorative rigid bodies on sides of the decorative rigid bodies opposite to their flat sides. The spacer layer is adhered to the top layer in regions peripheral to the decorative rigid bodies. The spacer layer has a plurality of through holes each accommodating at least one of the decorative rigid bodies. A thickness of the spacer layer is larger than a distance between the flat sides of the decorative rigid bodies and the top layer. The spacer layer is provided with a resiliency sufficient to, upon exertion of a force onto the top layer, reduce the thickness of the spacer layer to become equal to the distance between the flat sides of the decorative rigid bodies and the top layer. An adhesive is applied to the flat sides of the decorative rigid bodies.

According to an embodiment, no adhesive is present on the surface of the spacer layer opposite the top layer.

According to an embodiment, the transfer strip further includes an array of registration marks, wherein a pitch of the array of registration marks is equal to a pitch of the array of decorative rigid bodies.

According to an embodiment, the transfer strip further includes an array of separator marks, wherein each separator mark includes a reduced cross section of the transfer strip layers, and wherein the reduced cross section is positioned between successive ones of the array of decorative rigid bodies.

According to an embodiment, the decorative rigid bodies are multi-faceted and transparent.

Embodiments relate to a cartridge containing a carrier strip carrying an array of decorative rigid bodies each having at least one flat surface. The cartridge comprises an uptake reel carrying a first portion of the carrier strip without decorative rigid bodies and a driven reel carrying a second portion of the carrier strip with the array of decorative rigid bodies. The decorative rigid bodies are positioned on the second portion of the carrier strip with their respective flat surfaces facing outside, and wherein the decorative rigid bodies are placed in through holes of a spacer layer slightly thicker than the decorative rigid bodies.

According to an embodiment, the driven reel and the uptake reel each comprise at least one of a brake and a spring tensioning the carrier strip.

According to an embodiment, the carrier strip is the transfer strip mentioned above.

According to an embodiment, the cartridge further comprises a drive reel adapted to engage with a drive shaft of an external drive assembly.

According to an embodiment, the cartridge further comprises a guide reel, wherein the guide reel and the drive reel are configured and arranged so that the driven reel and the uptake reel are arranged in parallel planes.

According to an embodiment, the guide reel and the drive reel each have frustoconical circumferences.

Embodiments relate to an apparatus for transferring decorative rigid bodies each having at least one flat side from a carrier strip carrying the decorative rigid bodies onto a substrate. The apparatus comprises a first reel for carrying the carrier strip with the decorative rigid bodies, a second reel for receiving the carrier strip after the decorative rigid bodies have been transferred to the substrate, and one of a cam, a hammer and a transfer reel, located at a position between the first reel and the second reel as measured along the carrier strip, and adapted for individually bringing the decorative rigid bodies into contact with the substrate.

According to an embodiment, the apparatus further comprises a drive for the cam, wherein the cam is rotatably mounted (mounted in rotatable manner) so that a rotation of the driven cam is registered with a transportation of the carrier strip from the first reel to the second reel, and the cam is arranged to exert a force onto the carrier strip such that the flat side of at least one of the decorative rigid bodies protrudes from the apparatus.

According to an embodiment, the apparatus further comprises an actuator for the hammer, wherein the hammer is reciprocatingly mounted (mounted in reciprocating manner) so that an outward motion of the hammer is registered with a transportation of the carrier strip from the first reel to the second reel, and the hammer is arranged to exert a force onto the carrier strip such that the flat side of at least one of the decorative rigid bodies is protruded from the apparatus.

According to an embodiment, the transfer reel is mounted so that, upon its turning, at least one of the decorative rigid bodies protrudes from the apparatus.

According to an embodiment, the transfer reel is mounted in a casing, and the casing is reciprocatingly movable (movable in reciprocating manner) in a protrusion direction of the at least one of the decorative rigid bodies.

According to an embodiment, the transfer reel is resiliently mounted in the casing, wherein a gear is provided which translates a translational motion of the mounting of the transfer reel with respect to the casing, into a forwarding motion of the carrier strip.

According to an embodiment, the above mentioned apparatus comprises the above mentioned cartridge.

Embodiments relate to a method of fixing decorative elements to a substrate. The method comprises placing a transfer strip on the substrate and exerting a force onto the transfer strip, such that the resilient spacer layer is compressed, such that the adhesive on the surfaces of the decorative elements opposite to the top layer comes into contact with the substrate. The transfer strip includes the decorative elements, a spacer layer having through holes accommodating the decorative elements and a top layer adhered to the spacer layer and to the decorative elements, wherein the spacer layer is resilient and wherein surfaces of the decorative elements opposite to the top layer carry an adhesive. The method further comprises, when the decorative elements adhere to the substrate, releasing the force exerted on the transfer strip, removing the spacer layer from the substrate, and releasing the adherence between the top layer and the decorative elements by exerting an upward drag on the top layer, leaving the decorative elements behind adhered to the substrate.

According to an embodiment, the force is exerted manually on the transfer strip.

According to an embodiment, the force is exerted by an automated apparatus.

According to an embodiment, the apparatus detects a registration mark provided on the transfer strip, and initiates exertion of the force in dependence of the detection of a registration mark.

According to an embodiment, the apparatus initiates exertion of the force at a predetermined time after the detection of the registration mark.

According to an embodiment, the apparatus initiates exertion of the force at a predetermined position on the transfer strip relative to a position of the detected registration mark.

According to an embodiment, the method comprises using the apparatus mentioned above.

Embodiments relate to a picture frame comprising an array of decorative rigid bodies adhered to a frame, the array surrounding one of a picture and a photograph.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

Exemplary embodiments will now be described by reference to the appended drawings:

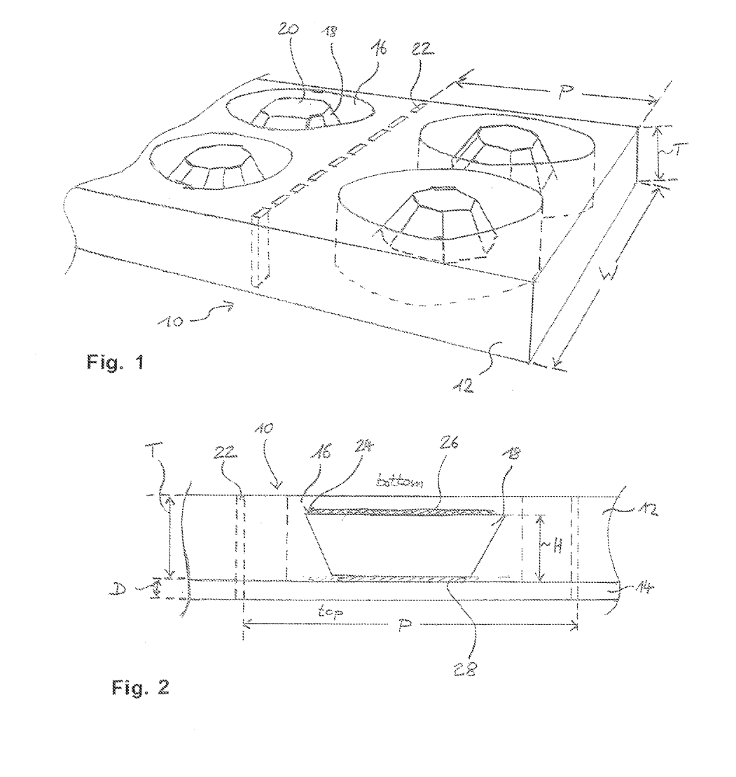

FIG. 1 is a perspective view of a part of the transfer tape, with the top layer removed for clarity;

FIG. 2 is a side view of the transfer tape of FIG. 1 including the top layer;

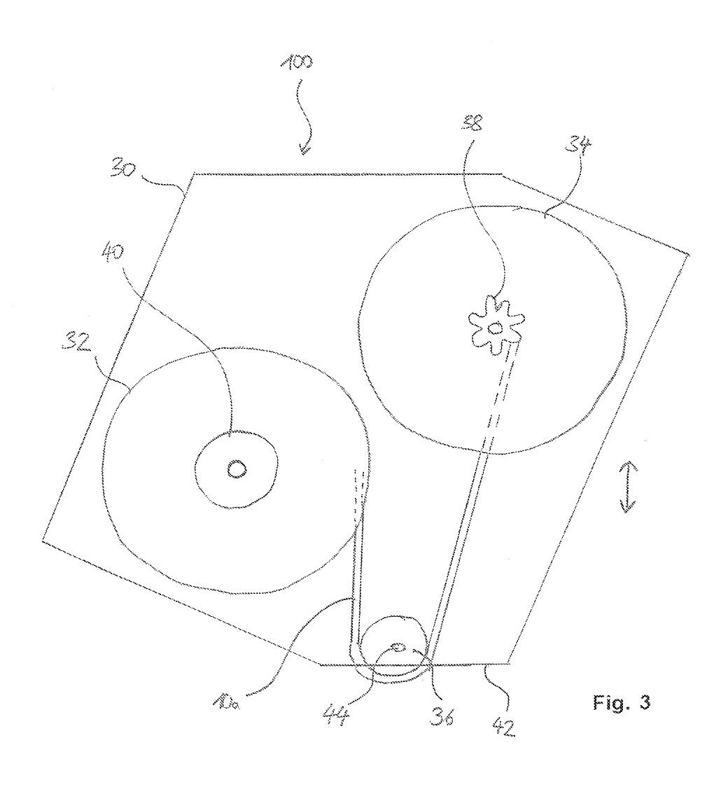

FIG. 3 shows a cartridge accommodating a transfer tape;

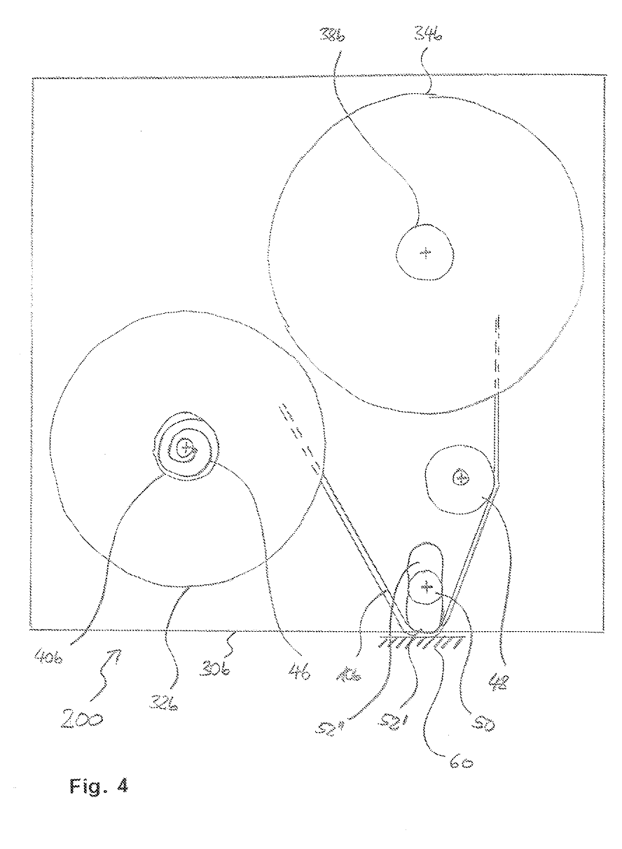

FIG. 4 shows an apparatus with a cam acting on the top layer of the transfer tape;

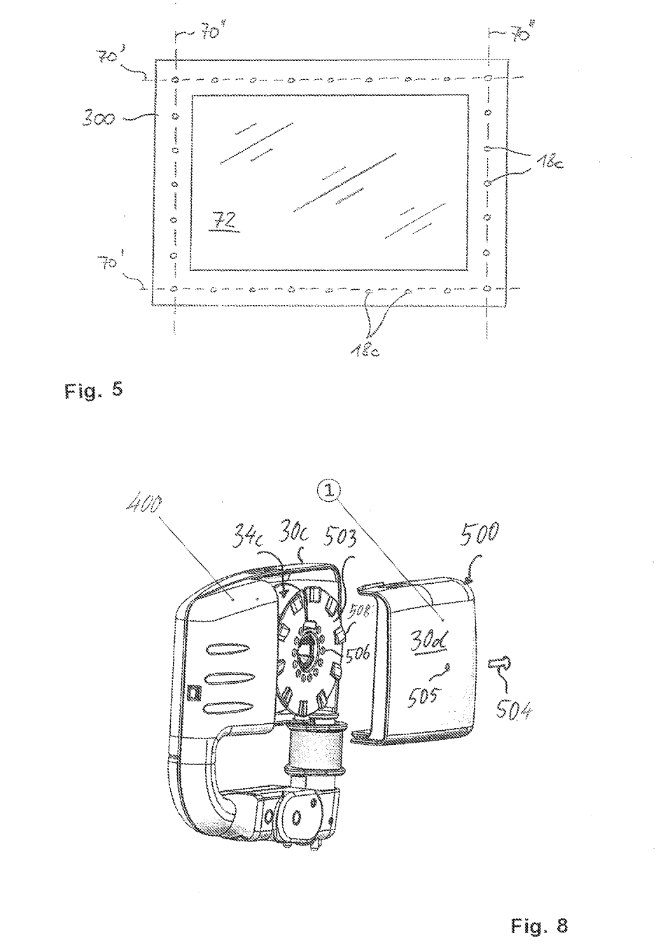

FIG. 5 is a picture frame with decorative elements applied alongside the outer rim of the picture;

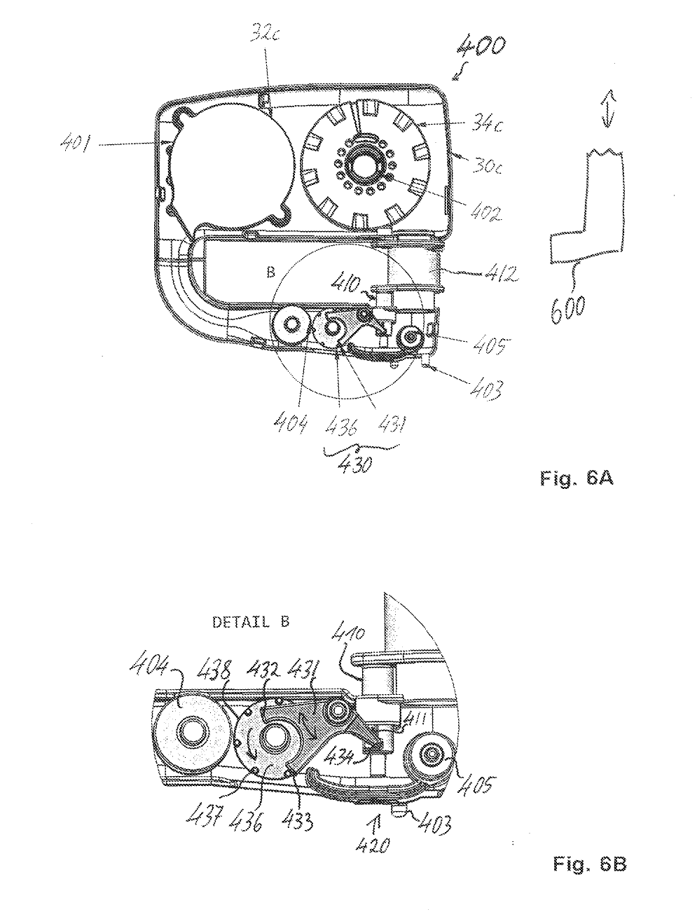

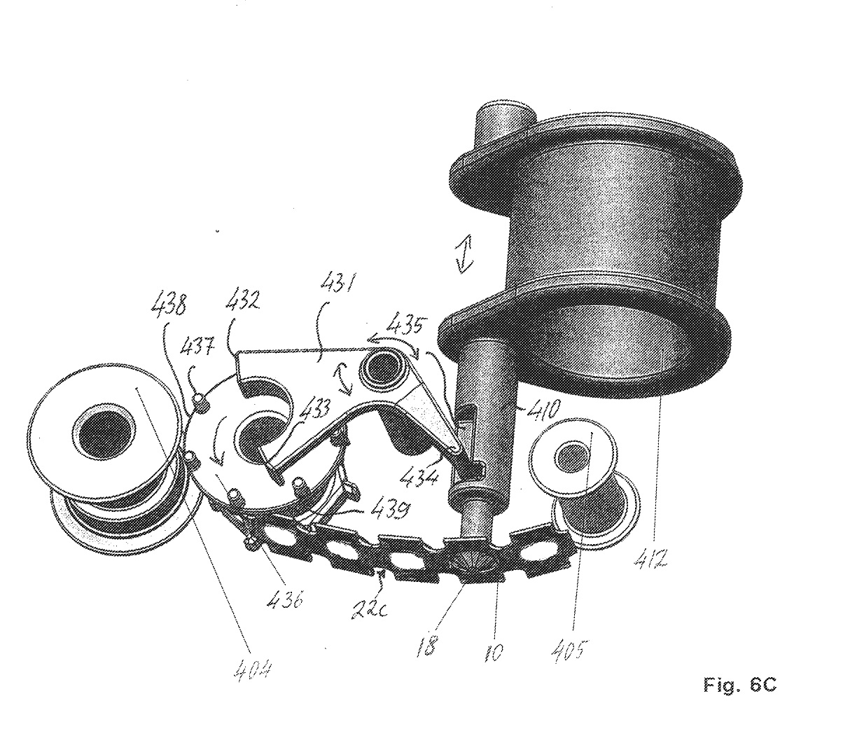

FIG. 6A is a side view on an apparatus for transferring decorative rigid bodies where one side of a casing of the apparatus has been removed;

FIG. 6B is an enlarged view on details of FIG. 6A;

FIG. 6C is an enlarged perspective view on details of FIG. 6A where the casing has been omitted completely;

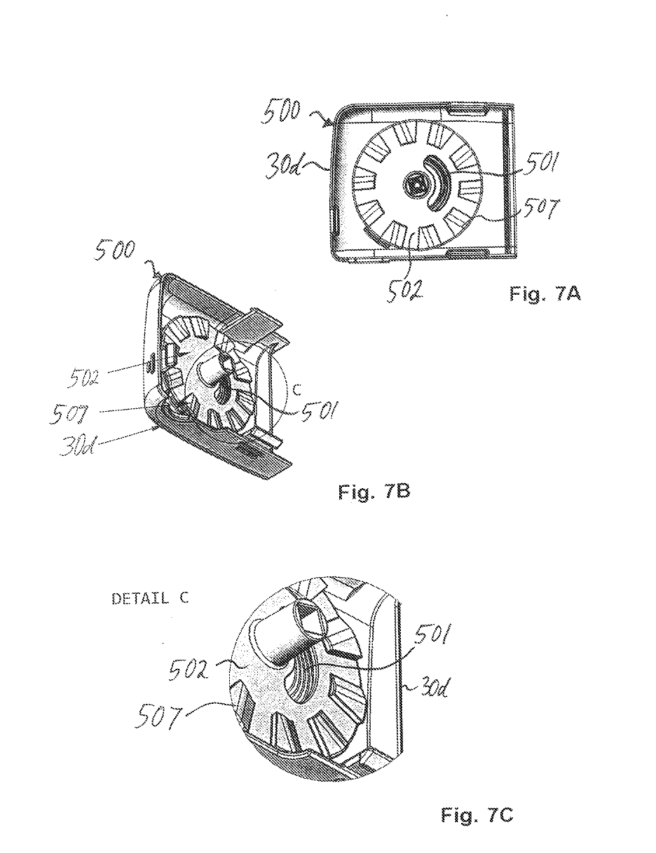

FIG. 7A is a side view on a releasable part for the apparatus of FIG. 6;

FIG. 7B is perspective view on the releasable part of FIG. 7A;

FIG. 7C is an enlarged view on details of FIG. 7B; and

FIG. 8 is a perspective view showing how the releasable part of FIGS. 7A-7C is mounted to the apparatus of FIGS. 6A and 6B.

FIG. 1 shows a leading end of a transfer tape 10, without its top layer. The transfer tape has a spacer layer 12 with through holes 16, in which rigid bodies 18 such as multifaceted decorative elements are accommodated. Although not shown in FIG. 1, the rigid bodies contact the top layer at their faces 20, via an adhesive at least between the top layer and the respective faces. The same, or a different adhesive may be present between the spacer layer 12 and the top layer. The rigid bodies are arrayed with a pitch P in the spacer layer 12, which has a width W of e.g. about 5.5 mm, or more generally 4 to 10 mm, and a thickness T of about 1.0 mm (more generally, 0.9 to 1.5 mm). The rigid bodies have a height of about 0.75 mm (more generally, 0.5 to 1.0 mm). The pitch P may be about 3.0 mm, or 2.0 to 6.0 mm in general. It may be noted that the pitch of the through holes 16 of the spacer layer 12, or of registration features 22 of the tape, need not be identical to the pitch of the rigid bodies. E.g., it is also contemplated that only every other through hole or row of through holes contains rigid bodies, so that the pitch of the rigid bodies 18 may be twice (or another integer multiple of) the pitch of the through holes 16 or of the registration marks 22. Generally the pitches would be commensurate in order that the rigid bodies 18 may be precisely positioned on a substrate.

FIG. 2 is a side view of the transfer tape, with the top layer 14 at the bottom, and one rigid body 18 accommodated in one hole 16 in the spacer layer 12. It may be noted that the hole 16 does not extend through the top layer 14, while the registration marks 22 may do so, but need not. The rigid body 18 has one face 24 opposite the top layer 14 which is not only flat, but preferably also substantially parallel to the top layer 14. The top layer 14 has a thickness D which is generally much less than the thickness T of the spacer layer, e.g. D is about 0.1 mm. The spacer layer thickness T is also somewhat larger than the distance H of the opposing flat face 24 of the rigid body 18 from the top layer 14. Specifically, the difference between the values of T on the one hand, and H on the other, may be e.g. 0.25 mm, or more generally 0.1 mm to 0.5 mm, depending on the intended use and also depending on the resiliency of the spacer layer. Herein, “resiliency” is intended to mean the compression in thickness direction per unit pressure (or force) in that direction. More specifically, the force exerted on the top layer is envisaged to act, via the rigid body, on the substrate, without being overly reduced by the elastic force of the spacer layer 12. Generally, the thickness difference T-H of the spacer layer vs. the rigid body shall be sufficiently small, that the elastic force exerted by the spacer layer when compressed by the same distance T-H may not exceed 10% of the maximum force which can be reasonably expected to be exerted on the top layer 14.

The residual force, by which the rigid body (where “rigid” means: having a compression per unit pressure in the thickness direction sufficiently smaller than that of the spacer layer 12, e.g. at most 10% or 1% compression) is maximally pressed on the substrate, is envisaged to cause an adhesive 26 provided on the flat face 24 of the rigid body to adhere the rigid body 18 to the substrate via the flat face 24. The adhesive 26 may, but need not be the same as the adhesive 28 provided between the top layer 14 and the rigid body 18.

In the exemplary embodiment of FIGS. 1 and 2, the marks 22 are rectangular perforations extending through the tape. However, differently shaped perforations, or other means of providing a reduced cross section of the tape material may be envisaged. The function of the perforations in this example is two-fold: Firstly, the perforations 22 provide an indication of the exact position of the tape, and thus serve as registration marks. In order to fulfill this function, it is preferably for the registration marks to be arranged at a pitch commensurate with that of the rigid bodies, as explained above. Secondly, the perforations 22 may serve as separator marks, i.e. positions where the end portion of the tape may easily be manually separated from the remaining tape. In this manner, manual application of one or more decorative elements is facilitated, in that the used tape end devoid of decorative elements can easily be ripped off the remaining tape still accommodating elements. For the separator marks to serve this second function, it is desirable if they are arranged between the rows of holes housing the decorative (or otherwise rigid) elements, in the longitudinal direction of the tape perpendicular to the width direction and the thickness direction. While in the exemplary embodiment of FIGS. 1 and 2, both functions are fulfilled by the same marks, it is equally envisaged to provide distinct registration and separator marks. In this case, the registration marks need not consist of physical recesses at all, but it is sufficient if perceivable marks are present, to be detected visually or by any other means.

The rigid bodies 18 themselves are shown in FIGS. 1 and 2 as being multi-faceted crystals. While it is generally also envisaged that the circumference and even the part facing the top band 14 may be rounded, the one face 24 opposite the top band 14 is desirably flat and parallel to the top band 14. In order to provide a pronounced decorative effect it is generally desirable that also the circumferential faces are flat, thereby providing multiple reflections in the crystal. It is also generally desirable for the rigid material to be highly transparent at least to visible light and to provide a relatively high index of refraction and/or a low Abbé number. The material need not be crystalline in the chemical sense of a regular atomic array, but may be amorphous. One particularly desirable choice of material is glass, particularly glass with a lead content (such as more than about 10 wt % PbO). The angles formed between adjacent facets of the (usually, generally convex) rigid bodies may be chosen in dependence of the refractive index and Abbé number for providing for particularly pronounced dispersion of incident light, to enhance their decorative effect.

The force required to release the rigid bodies from the top layer 14 after their being adhered to a substrate needs to be sufficiently low as not to instead release the rigid bodies from the substrate. To this end, the adhesive 28 provided between the rigid bodies 18 and the top layer 24 may be weaker in terms of the release force per unit adhering area, than the adhesive 26 provided between the rigid bodies and the substrate. Additionally or alternatively, the shapes of the rigid bodies may be such that the faces 24 opposing the top layer 14 are sufficiently smaller than the faces with which the rigid bodies adhere to the top layer, that the required effect is achieved even though the same type of adhesive is used on both faces.

The releasing of the top layer from the rigid bodies after their adhering to a substrate will also be supported by the resilient force exerted on the top layer by the spacer layer; and may be further facilitated at least in manual applications, by a bending of the transfer tape 10, so that the releasing action is effected sequentially across each adhering face rather than simultaneously on the entire face. Similarly, in an automatic application method, it is desirable to provide for sufficiently large angles between the two outwardly extending portions of the tape, and the substrate surface. Specifically, angles larger than about 30° or larger than 45° or larger than 60° may be desirable. This is because the force to be exerted on the top layer for releasing it from the rigid bodies already adhered to the substrate, has to be provided through the two portions of the tape extending outwardly from the position where the rigid bodies are currently released. Elementary physics predict that the force component along the longitudinal direction of the tape necessary for release is the smaller, the larger the above angles are, up to an ideal 90°.

In FIG. 3, a cartridge housing a transfer tape is shown. Like entities are labeled with like reference numerals and appended letter for distinction. The cartridge 100 of this exemplary example has a housing 30 holding two reels 32, 34 for providing the transfer tape 10a with the rigid bodies for supply on the one end (driven reel 32), and the tape depleted of rigid bodies on the other end (drive reel 34). Between both reels 32 and 34, a transfer reel 36 may be provided, by which the rigid bodies (not shown) next to be transferred are exposed to outside of the casing 30. The drive reel 34 in this example has a drive hub 38, whereas the driven reel 32 has a hub 40 which is biased in the counter direction by means of a braking means or a coil spring or both, in order to keep the transfer tape tightly sprung around the hubs 38, 40. In an alternative embodiment not shown, both hubs 38 and 40 are biased outwardly by passive means such as springs, while a separate drive reel is provided between the uptake reel and the transfer reel.

The cartridge 100 may as a whole be maneuvered manually, or by means of a support mechanism (not shown), and in either manner may be brought in a transfer position with respect to a substrate to transfer one or a row of rigid bodies from the tape 10a onto the substrate, by exerting a force on the casing 30 towards the substrate (double arrow), whereby the exposed rigid body or bodies are adhered to the substrate. The tape itself may be the tape described above, i.e. the rigid bodies (not shown in FIG. 3) each have at least one flat face opposite a top layer, and with respect to the casing 30 of the cartridge, the flat faces of the rigid bodies conveniently also face outwardly. The casing 30 may be of any general shape, but conveniently is of general plate like or prismatic structure. One side 42 of the prism or plate supports the transfer reel, if present, and in some applications it may be desirable to provide a tab or other protruding structure supporting the hub 44 of the transfer reel 36. In another variant, which is not Shown, the uptake reel and the driven reel are not arranged in the same plane, but in laterally offset, parallel planes. This can be accomplished by providing a drive reel and another, guide reel which have slightly conical circumferences. If the directions of the respective cones are properly chosen, the tape will move out of its initial, driven reel plane when surrounding the guide reel, and will be guided into its final, uptake reel plane by the conical circumference of the drive reel. The transfer reel axis in between the guide reel and the drive reel would in this case be mounted slightly skewed (non-perpendicular) with respect to the driven reel plane and the uptake reel plane. The advantage is that the outer dimensions of the cartridge may be kept smaller, at the expense of a larger thickness.

In further exemplary embodiments, the motion of the rigid bodies towards the substrate is not (or not only) effected through a translation of the entire cartridge, but by additional features exerting the required force only on the portion of the top band holding the rigid bodies next to be transferred. Such feature may be a cam, hammer or the like.

One such embodiment is shown in FIG. 4. In this case, the casing 30b accommodates a driven reel 32b with a hub 40b biased by a coil spring 46 so as to keep the transfer tape 10b tensioned; an uptake reel 34b with hub 38b; a drive reel 48; and a cam reel 50 having cams 52′ and 52″. The hub 38b of the uptake reel 34b may also be tensioned by a coil spring, or may be loosely coupled to the driven reel 32b by a slip gear, such as by as rubber string around both hubs.

The drive reel 48 may have pins (not shown) engaging into notches or recesses of the transfer tape 10b, for moving the tape forward in exact registration with the rotation of the drive reel. The cam reel 50 may rotate in the same or in counter direction as the transfer tape 10b. Its function is as follows: The cam reel 50 is driven in such a manner that one of the cams 52′ or 52″, of which there may be less or more than two, urges the top layer of the transfer tape 10b out of the casing 30b, at precisely the instance that a rigid body accommodated in the transfer tape 10b is in the most outwardly position. This registration results in a force being exerted on the rigid body through the top layer, pressing the rigid body onto a substrate 60 indicated by hatching in FIG. 4. When the drive reel 48 is rotated further, so is the cam reel 50, and the transfer tape 10b is drawn back into the casing by the coil spring 40b. In this manner, it is possible to maintain the casing 30b in the same constant distance from the substrate, the movement of the rigid bodies towards the substrate being effected only by the cams 52′, 52″ acting on the rigid bodies through the top layer of the transfer tape 10b.

In a similar exemplary embodiment, not shown, the motion of the actuator is reciprocating rather than rotational. Namely, a kind of hammer is released to act on the rigid body in the transfer position, in registration with the forward motion of the transfer tape. After exerting the required force on the rigid body to make it adhere to the substrate, the hammer is withdrawn into the casing, and the transfer tape follows this inward motion by means of the elasticity of the spring.

In another exemplary embodiment not shown, the transfer reel is resiliently mounted in the casing, e.g. by means of a spring. When the casing as a whole is moved towards the substrate by an external force, the counterforce exerted by the substrate on the transfer tape and the transfer reel moves the mount of the transfer reel inwards the cartridge. This motion, or better still the subsequent return motion of the mount to its initial position under the force of the spring, is translated by a suitable gear into a forwarding motion of the transfer tape, thus bringing the two motions, i.e. reciprocating motion of the cartridge and the forwarding motion of the transfer tape, in registration. The gear may comprise a latch engaging into teeth of a toothed reel mounted on the hub of the drive reel. Simultaneous with the inward motion of the transfer reel mount, mounts of the drive reel and another, guide reel may be configured to move laterally apart in order to keep to overall free length of the tape between the driven reel and the uptake reel constant.

In all these apparatus, the motion of the drive reel and the actuating device require a supply of, most conveniently electric, energy. Specifically, there are motors provided effecting the required motions. Further, it is desirable to control the motion of the actuator (cam, hammer, or the like) such that it is precisely in registration with an external command, so that the positioning of the rigid body may be governed by a “printing” control. It is contemplated to accommodate the energy supply (such as a battery) and the motors, the motion control, or both, in a second casing (not shown) which is similarly prismatic, and conveniently matches the shape of the printing cartridge. For example, drive shafts and other actuators may be supported in the second casing, but may extend through matching openings in the casings, so that they may engage counterpart components in the printing cartridge. Naturally, the thicknesses of both casings may be different. In this embodiment, replacement of a used transfer tape may be particularly easily and cost efficiently effected, as the control part and actuator part need not be replaced at the same time. It may also be convenient to provide different transfer tapes, e.g. tapes with different kinds of rigid bodies, or different pitch or adhesive (for different substrate materials) of the rigid bodies, without the need to provide separate control or actuator parts. More particularly, the control part may comprise circuitry accepting conventional printing commands for effecting the positioning of the rigid bodies at desired positions on the substrate.

One example of how the embodiments described above can be used, is shown in FIG. 5, namely a rectangular frame 300 such as for a picture, where rows 70′, 70″ of decorative elements 18c surround the picture area 72. The skilled person will be aware that instead of single rows 70′, 70″, two or more parallel rows may be present, in which the decorative elements may also be staggered if so desired.

Another embodiment of an apparatus for transferring decorative rigid bodies will now be described by referring to FIGS. 6 to 8.

In this respect, FIG. 6A is a side view on an apparatus 400 for transferring decorative rigid bodies 18 such as crystals from a carrier strip 10 carrying the crystals 18 where one side of a casing 30c of the apparatus 400 has been removed and FIG. 6B is an enlarged view of region B of FIG. 6A. FIG. 6C is an enlarged perspective view on details of FIG. 6A where the casing has been omitted completely.

The apparatus 400 has a supply reel 32c covered by a supply reel cover 401. The carrier strip 10 carrying the crystals 18 is wound on the supply reel 32c. It is emphasized that usage of the supply reel 32c and/or the supply reel cover 401 is only optional. As an alternative, a cavity may be used to directly receive a part of the carrier strip carrying the crystals 18, for example.

The carrier strip 10 is successively guided by an upstream guide wheel 405, a timing wheel 436, a downstream guide wheel 404 and a reel 405 of the apparatus 400.

The reel 34c receives the part of the carrier strip 10 from which the decorative rigid bodies 18 have been transferred to a substrate (not shown in FIGS. 6A-6C). The reel 34c is biased by a coil spring 501. Description of the coil spring 501 is postponed.

The apparatus 400 further has a plunger 410 located at a transfer position 420 between the timing wheel 436 and the reel 34c as measured along the carrier strip 10. By grapping a bushing 412 of the plunger 410 with a clutch shaped actuator 600 or by hand the casing 30c and the plunger 410 can be moved up and down in a protrusion direction of the crystals 18 to bring the crystals 18 into contact with a substrate. As is obvious from the figures, the bushing allows a linear movement of the plunger 410, only.

In this respect, the casing 30c has three knobs 403 (only two knobs are shown in FIG. 6A) extending from the casing 30c in the protrusion direction of the apparatus 400 and surrounding the transfer position 420. The knobs 403 defining a mathematical contact plane for the substrate. In consequence, the three knobs 403 stop the movement of the casing 30c upon contact with the substrate 60, such that only the movement of the plunger 410 can continue. This results in a relative movement of the plunger 410 and the casing 30c. In the shown embodiment, the direction of the linear relative movement of the plunger 410 with respect to the casing 30c includes an angle of 90° with a mathematical contact plane defined by the knobs 403. This linear movement of the plunger 410 with respect to the casing 30c causes both transportation of the carrier strip 10 from the supply reel 32c to the reel 34c, and exertion of a force onto the carrier strip 10 such that a flat side 24 of at least one of the crystals 18 is protruded from the apparatus 400.

The bushing 412 surrounds a section of the carrier strip 10 from which the crystals 18 have been transferred between the transfer position 420 and the reel 34c.

A gear 430 consisting of a lever 431 and a timing wheel 436 is provided to synchronize the linear translational motion of the plunger 410 with respect to the casing 30c into a forwarding motion of the carrier strip 10.

As shown best in FIGS. 6B and 6C the lever 431 has a first end 434 engaging with an L-shaped groove 435 of the plunger 410 and two second ends 432, 433 alternatively engaging with one of seven protrusions 437 on a timing disc 438 forming a side surface of the timing wheel 436. The lever 431 is rotatable mounted about an axis between the first end 434 and the second ends 432, 433.

When the plunger 410 is linearly moved up and down the lever 431 is alternatively rotated by approximately 15° in a clockwise and an anti-clockwise direction. In doing so, either the outer side of the second end 433 or the inner side of the second end 432 blocks a movement of a protrusion 437 of the timing disc 438. Thus, rotation of the timing wheel by one pitch between the protrusions 437 of the timing disc 438 is stopped twice by the second ends 432, 433 of the lever 431.

As the protrusions 437 are arranged at an radially outmost position of the timing disc 438, a pitch between two neighboring protrusions 437 is larger than a pitch between two neighboring engagement features 22c of the carrier strip 10.

To firmly engage with the carrier strip 10 the timing wheel 436 comprises seven bosses 436 having a semicircular cross sections and being arranged next to the timing disc 438. The bosses 436 are adapted to engage the engagement features 22c of the carrier strip 10. Only one boss 436 is shown in FIG. 6C. To guarantee a strong seat between the timing wheel 436 and the carrier strip a pitch between bosses 436 of the timing wheel 436 is 1% larger than a pitch between engagement features 22c of the carrier strip 10.

To guarantee that at least two bosses 436 engage with engagement features 22c of the carrier strip 10 at any time the upstream guide wheel 405 is arranged such that it causes the carrier strip 10 to bend around the timing wheel 436 by an angle of 25°.

Now the coil spring 501 biasing the reel 34c will be described in further detail by referring to FIGS. 7A-7C and 8.

In this respect, FIG. 7A is a side view on a releasable part 500 for the apparatus 400 of FIG. 6, FIG. 7B is perspective view on the releasable part 500 of FIG. 7A, FIG. 7C is an enlarged view on detail C of FIG. 7B and FIG. 8 is a perspective view showing how the releasable part 500 of FIGS. 7A-7C is mounted to the apparatus 400 of FIGS. 6a and 6B.

As shown in FIGS. 7A-7C, the apparatus 400 has a releasable part 500 essentially consisting of a casing 30d in which a matching disk 502 having radially extending cogs 507 are mounted. The coil spring 501 is mounted in-between the matching disk 502 and the casing 30d. One end of the coil spring 501 is attached to the casing 30d and the other end is attached to the matching disk 502. By rotating the matching disk 502, rotational energy can be stored in the coil spring 501. This energy can be used for tensioning 501 the carrier strip 10 towards the reel 34c when the releasable part 500 is fitted to the casing 30c of the apparatus 400. The reel 34c has an outer side forming a matching disk 503 having cogs 508 arranged to engage with the cogs 507 of the matching disk 502.

To facilitate mounting of the releasable part 500 to the apparatus 400 in a state where energy is stored in the coil spring 501 a pin 504 is provided. The pin 504 is guided by a hole 505 in the casing 30d and engages with one hole 506 provided in the matching disk 503 of reel 34c. Thus, rotation of the reel 34c can be blocked by using the pin when the tensioning means are tensioned.

It should be noted in this context that the terms “comprise”, “include”, “having” and “with”, as well as grammatical modifications thereof used in this specification or in the claims, indicate the presence of technical features such as stated components, figures, integers, steps or the like, and by no means preclude the presence or addition of one or more alternative features, particularly other components, figures, integers, steps or groups thereof.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

1-23. (canceled)

24. Apparatus for transferring decorative rigid bodies each having at least one flat side from a carrier strip carrying the decorative rigid bodies onto a substrate, the apparatus comprising:
a holding fixture for accommodating a part of the carrier strip with the decorative rigid bodies;
a wheel for receiving a part of the carrier strip from which the decorative rigid bodies were transferred to the substrate;
and a reciprocator located between the holding fixture and the wheel, and adapted for individually bringing the decorative rigid bodies into contact with the substrate by substantially linear movement of the reciprocator, and
a casing, wherein the reciprocator is mounted on or in the casing, and is reciprocatingly movable in a protrusion direction of the at least one of the decorative rigid bodies with respect to the casing, wherein a gear is provided which synchronizes the motion of the reciprocator with respect to the casing, into a forwarding motion of the carrier strip.

25. The apparatus according to claim 24, wherein the gear includes a latch engaging the wheel such that the reciprocating motion alternatingly causes blocking and releasing the wheel.

26. The apparatus according to claim 25, wherein the timing wheel carries protrusions for engagement with the latch.

27. The apparatus according to claim 26, wherein the wheel comprises bosses adapted to engage into engagement features of the carrier strip.

28. The apparatus according to claim 24, comprising an actuator for the reciprocator, which is arranged to exert a force onto the carrier strip such that the flat side of at least one of the decorative rigid bodies is protruded from the apparatus, and is reciprocatingly mounted so that an outward motion of the reciprocator is registered with transportation of the carrier strip.

29. Apparatus for transferring decorative rigid bodies each having at least one flat side from a carrier strip carrying the decorative rigid bodies onto a substrate, the apparatus comprising:
a holding fixture for accommodating a part of the carrier strip with the decorative rigid bodies;
a reciprocator adapted for individually bringing, at a transfer position, the decorative rigid bodies into contact with the substrate by substantially linear movement of the reciprocator, and resiliently mounted in a casing; and
a transfer rail for receiving the part of the carrier strip with the decorative rigid bodies and guiding it past the transfer position;
wherein the reciprocator is reciprocatingly movable in a protrusion direction of the at least one of the decorative rigid bodies with respect to the casing, wherein the motion of the reciprocator with respect to the casing is synchronized with a forwarding motion of the carrier strip.

30. The apparatus of claim 29, wherein an outward motion of the reciprocator is registered with transportation of the carrier strip.

31. A carrier strip for use with an apparatus comprising:
a holding fixture for accommodating a part of the carrier strip with the decorative rigid bodies; and
a reciprocator adapted for individually bringing the decorative rigid bodies into contact with a substrate by substantially linear movement of the reciprocator,
the carrier strip carrying the decorative rigid bodies each having at least one flat side and to be transferred to the substrate through openings formed in the carrier strip, the carrier strip including separator marks having a reduced cross-section, between longitudinally adjacent ones of the openings.

32. The carrier strip of claim 31, wherein the decorative rigid bodies have flat outward sides to which an adhesive is applied.

33. The carrier strip of claim 31, wherein the decorative rigid bodies are accommodated in pouches.

34. The carrier strip of claim 33, wherein the pouches are arranged at the same pitch as the separator marks.

35. The carrier strip of claim 31, further comprising a top layer arranged on a spacer layer.

36. The carrier strip of claim 31, wherein the apparatus comprises:
a holding fixture for accommodating a part of the carrier strip with the decorative rigid bodies;
a wheel for receiving a part of the carrier strip from which the decorative rigid bodies were transferred to the substrate;
and a reciprocator located between the holding fixture and the wheel, and adapted for individually bringing the decorative rigid bodies into contact with the substrate by substantially linear movement of the reciprocator,
the apparatus comprising a casing, wherein the reciprocator is mounted on or in the casing, and is reciprocatingly movable in a protrusion direction of the at least one of the decorative rigid bodies with respect to the casing, wherein a gear is provided which synchronizes the motion of the reciprocator with respect to the casing, into a forwarding motion of the carrier strip.

37. The carrier strip of claim 31, wherein the apparatus comprises:
a holding fixture for accommodating a part of the carrier strip with the decorative rigid bodies;
a reciprocator adapted for individually bringing, at a transfer position, the decorative rigid bodies into contact with the substrate by substantially linear movement of the reciprocator, and resiliently mounted in a casing; and
a transfer rail for receiving the part of the carrier strip with the decorative rigid bodies and guiding it past the transfer position;
wherein the reciprocator is reciprocatingly movable in a protrusion direction of the at least one of the decorative rigid bodies with respect to the casing, wherein the motion of the reciprocator with respect to the casing is synchronized with a forwarding motion of the carrier strip.

38. A method of transferring decorative rigid bodies each having at least one flat side from a carrier strip carrying the decorative rigid bodies onto a substrate, the method comprising exerting, manually or automatically, a pressure on the decorative rigid bodies individually by a substantially linear movement of a reciprocator with respect to a casing in which the reciprocator is resiliently mounted, such that an adhesive provided on the flat side of each individual decorative rigid bodies comes into contact with the substrate and adheres thereto, and synchronizing a forwarding motion of the carrier strip with the substantially linear motion.

39. The method of claim 38, wherein the carrier strip comprises:
a holding fixture for accommodating a part of the carrier strip with the decorative rigid bodies; and
a reciprocator adapted for individually bringing the decorative rigid bodies into contact with a substrate by substantially linear movement of the reciprocator,
the carrier strip carrying the decorative rigid bodies each having at least one flat side and to be transferred to the substrate through openings formed in the carrier strip, the carrier strip including separator marks having a reduced cross-section, between longitudinally adjacent ones of the openings.

40. The method of claim 38, wherein the exerting of the pressure includes using apparatus comprising:
a holding fixture for accommodating a part of the carrier strip with the decorative rigid bodies;
a wheel for receiving a part of the carrier strip from which the decorative rigid bodies were transferred to the substrate;
and a reciprocator located between the holding fixture and the wheel, and adapted for individually bringing the decorative rigid bodies into contact with the substrate by substantially linear movement of the reciprocator,
the apparatus comprising a casing, wherein the reciprocator is mounted on or in the casing, and is reciprocatingly movable in a protrusion direction of the at least one of the decorative rigid bodies with respect to the casing, wherein a gear is provided which synchronizes the motion of the reciprocator with respect to the casing, into a forwarding motion of the carrier strip.

41. A method for applying decorative rigid elements from a carrier strip carrying the decorative rigid bodies onto a substrate, the method comprising:
moving a casing carrying a transfer rail towards the substrate by an external force, beyond the point where the transfer rail or its mount contacts the substrate, wherein the transfer rail is resiliently mounted in the casing such that the counterforce exerted by the substrate on the transfer rail mount moves the latter inwards the cartridge; and
subsequently, releasing the external force so that the mount outwardly returns to its original position,
wherein the inward or outward motion of the mount is translated into a forwarding motion of the carrier strip guided around the transfer rail.

42. The method of claim 41, wherein the carrier strip comprises:
a holding fixture for accommodating a part of the carrier strip with the decorative rigid bodies; and
a reciprocator adapted for individually bringing the decorative rigid bodies into contact with a substrate by substantially linear movement of the reciprocator,
the carrier strip carrying the decorative rigid bodies each having at least one flat side and to be transferred to the substrate through openings formed in the carrier strip, the carrier strip including separator marks having a reduced cross-section, between longitudinally adjacent ones of the openings.

43. The method of claim 41, wherein the step of moving the casing includes moving apparatus comprising:
a holding fixture for accommodating a part of the carrier strip with the decorative rigid bodies;
a reciprocator adapted for individually bringing, at a transfer position, the decorative rigid bodies into contact with the substrate by substantially linear movement of the reciprocator, and resiliently mounted in a casing; and
a transfer rail for receiving the part of the carrier strip with the decorative rigid bodies and guiding it past the transfer position;
wherein the reciprocator is reciprocatingly movable in a protrusion direction of the at least one of the decorative rigid bodies with respect to the casing, wherein the motion of the reciprocator with respect to the casing is synchronized with a forwarding motion of the carrier strip.
